(19) United States
(12) Patent Application Publication
(10) Pub. No.: US 2016/0072704 A1
(43) Pub. Date: Mar. 10, 2016

(54) RESOURCE CONTROL FOR VIRTUAL DATACENTERS

(71) Applicant: Microsoft Corporation, Redmond, WA (US)

(72) Inventors: Sebastian Angel, Austin, TX (US); Hitesh Ballani, Cambridge (GB); Thomas M. Talpey, Stow, MA (US); Thomas Karagiannis, Cambridge (GB); Eno Thereska, Cambridge (GB); Gregory O'Shea, Cambridge (GB)

(21) Appl. No.: 14/481,765

(22) Filed: Sep. 9, 2014

(51) Int. Cl. H04L 12/721; H04L 12/911; H04L 12/813

(52) U.S. Cl. CPC H04L 45/38; H04L 47/20; H04L 47/70

(57) ABSTRACT

Resource control for virtual datacenters is described, for example, where a plurality of virtual datacenters are implemented in a physical datacenter to meet guarantees. In examples, each virtual datacenter specifies a plurality of different types of resources having throughput guarantees which are met by computing, for individual flows of the virtual data centers implemented in the physical datacenter, a flow allocation. For example, a flow allocation has, for each of a plurality of different types of physical resources of the datacenter used by the flow, an amount of the physical resource that the flow can use. A flow is a path between endpoints of the datacenter along which messages are sent to implement a service. In examples, the flow allocations are sent to enforcers in the datacenter, which use the flow allocations to control the rate of traffic in the flows.

In recent years, cloud platforms such as datacenters have evolved from providing simple on-demand compute to offering a large selection of services. For example, networked storage, monitoring, load balancing and elastic caching. These services are often implemented using resources such as in-network middleboxes like encryption devices and load balancers, as well as resources such as end devices like networked storage servers. The adoption of such services is also common across a broad scale, from small to enterprise datacenters. While tenants (i.e. customers of these cloud computing services) can build their applications atop these services, doing so results in a major drawback: volatile application performance caused by shared access to contended resources. This lack of isolation hurts the provider too, as overloaded resources are more prone to failure and service level agreements cannot be met.

The embodiments described below are not limited to implementations which solve any or all of the disadvantages of known datacenter resource control systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Resource control for virtual datacenters is described, for example, where a plurality of virtual datacenters are implemented in a physical datacenter to meet guarantees. In examples, each virtual datacenter specifies a plurality of different types of resources having throughput guarantees which are met by computing, for individual flows of the virtual data centers implemented in the physical datacenter, a flow allocation. For example, a flow allocation has, for each of a plurality of different types of physical resources of the datacenter used by the flow, an amount of the physical resource that the flow can use. A flow is a path between endpoints of the datacenter along which messages or other elements of work are sent to implement a service. In examples, the flow allocations are sent to enforcers in the datacenter, which use the flow allocations to control the rate of traffic in the flows. Examples of other elements of work are CPU time, storage operations, cache allocations. A flow consumes part of one or more shared resources and the examples described herein manage this sharing relative to other demands and to absolute parameters.

In various examples, available capacity of shared resources is dynamically estimated. In some examples, the flow allocations are computed using a two-stage process involving local, per-virtual data center allocations and then a global allocation to use any remaining datacenter resources. The term “capacity” here refers to performance capacity, or available capacity, rather than to the size of a resource.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a datacenter arranged to provide a plurality of virtual datacenters to tenants;

FIG. 2 is a schematic diagram of a logically centralized controller of the datacenter of FIG. 1;

FIG. 3 is a schematic diagram of a plurality of compute servers of a datacenter and with an exploded view of one of the compute servers;

FIG. 4 is a schematic diagram of a virtual datacenter, such as one of the virtual datacenters of FIG. 1;

FIG. 5 is a schematic diagram of the virtual datacenter of FIG. 4 showing two example end-to-end flows;

FIG. 6 is a flow diagram of a method at the logically centralized controller of FIG. 2 for generating and sending instructions to enforcers at compute servers of a datacenter;

FIG. 7 is a flow diagram of a method at the logically centralized controller of FIG. 2 for computing a local flow allocation;

FIG. 8 is a flow diagram of a method at the logically centralized controller of FIG. 2 for computing a global flow allocation;

FIG. 9 is a flow diagram of a method at a capacity estimator of the logically centralized controller of FIG. 2;

FIG. 10 is a flow diagram of a process at a demand estimator of the logically centralized controller of FIG. 2 and of a process at an enforcer;

FIG. 11 is a schematic diagram of an end-to-end flow in a datacenter, an enforcer, and of a process at the enforcer;

FIG. 12 illustrates an exemplary computing-based device in which embodiments of a centralized datacenter controller may be implemented.

The same reference numerals are used to designate similar parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In the examples described below algorithms and equipment for use at datacenters is described which enables datacenter tenants to be offered dedicated virtual datacenters. A virtual datacenter describes end-to-end guarantees, which in some examples are specified in a new metric. For example, a tenant may specify a minimum or absolute throughput guarantee for each resource of the virtual data center. The algorithms and equipment described herein enable the guarantees to be independent of tenants' workloads and seek to ensure the guarantees hold across distributed datacenter resources of different types and the intervening datacenter network. Previous approaches have not enabled virtual datacenters to be provided in this manner.

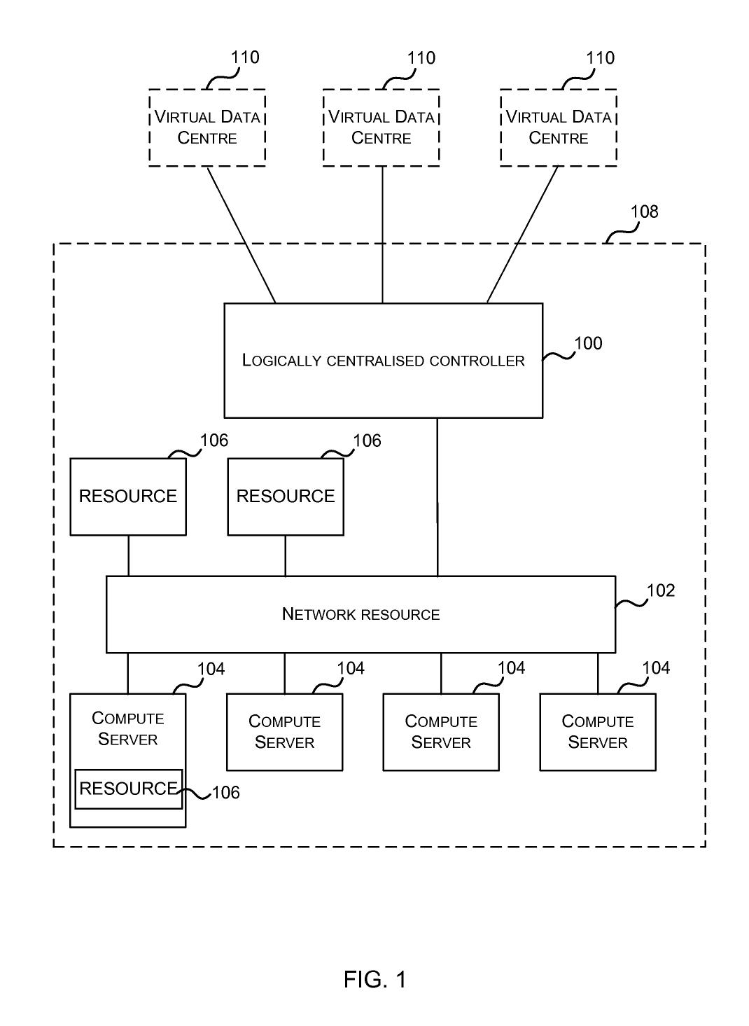

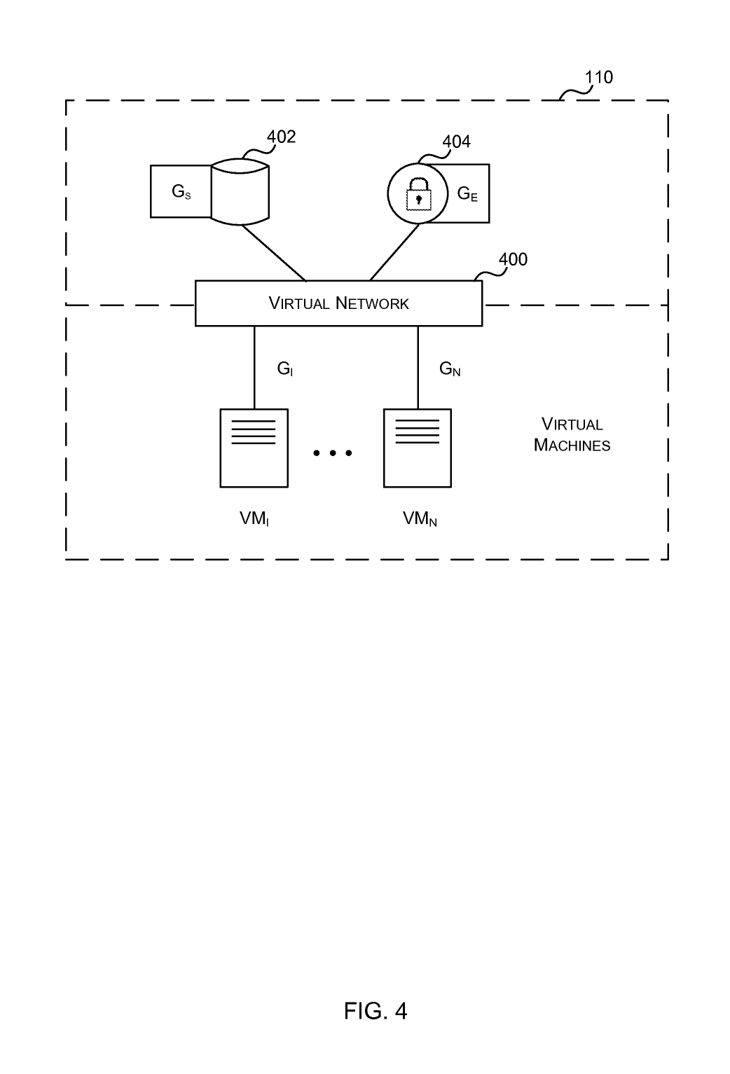

FIG. 1 is a schematic diagram of a datacenter 108 arranged to provide a plurality of virtual datacenters 110 to tenants. A virtual datacenter is a specification of requirements for performance of different types of resources of a physical datacenter that a tenant desires to rent. More detail about virtual datacenters is given below with reference to FIG. 4. The datacenter 108 comprises a plurality of different types of resources. These include compute servers 104 and network resource 102 which interconnects the compute servers as well as additional resources 106. In the example of FIG. 1 four compute servers 104 are shown for clarity but any two or more compute servers may be used.

The additional resources 106 may be in-network resources or end point resources. A non-exhaustive list of examples of resources is: network link, encryption device, load balancer, networked storage server, key value pair store. Thus the datacenter has different types of resources. Each resource has a capacity that can vary over time and a cost function that maps a request's characteristics into the cost (in tokens) of servicing that request at the resource.

The datacenter 108 comprises a logically centralized controller 100 which is computer implemented using software and/or hardware and which is connected to the network resource 102. The logically centralized controller may be a single entity as depicted in FIG. 1 or it may be distributed amongst a plurality of entities in the datacenter 108. The logically centralized controller 100 maps the virtual datacenters 110 onto the physical datacenter 108. It also carries out a resource allocation process so that resources of the physical datacenter, which are shared by the different virtual datacenters, are used efficiently whilst meeting requirements/guarantees of the virtual datacenters. The resource allocation process is repeated at control intervals so that changes in the datacenter may be taken into account.

A virtual datacenter has one or more virtual end-to-end flows of traffic that are to be implemented in the physical datacenter using a plurality of resources, such as network resources, encryption devices, load balancers, key value pair stores and others. The logically centralized controller specifies amounts of the plurality of different types of datacenter resources that may be used by the end-to-end flows implemented in the physical datacenter at repeated control intervals. In some examples, it takes into account capacity estimates (which may be dynamic) of datacenter resources, as part of the allocation process. Demands associated with the end-to-end flows may also be monitored and taken into account. The logically centralized controller sends instructions to rate controllers at end points of the end-to-end flows in the physical datacenter, specifying amounts of different resources of the flow which may be used. The rate controllers adjust queues or buckets which they maintain, in order to enforce the resource allocation. For example, there is one bucket for each different resource of an end-to-end flow. Previous approaches have not specified individual amounts of a plurality of different resources which may be used by an end-to-end flow. In this way a plurality of resources contribute together to achieve a higher-level flow.

An end-to-end flow is a path in a datacenter between two end points such as virtual machines or compute servers, along which traffic is sent to implement a service. For example, traffic may comprise request messages sent from a virtual machine to a networked file store and response messages sent from the networked file store back to the same or a different virtual machine. An end-to-end flow may have endpoints which are the same; that is, an end-to-end flow may start and end at the same endpoint.

One or more parts of the controller may be computer implemented using software and/or hardware. In some examples the demand estimator, capacity estimator and the resource allocator are implemented, in whole or in part, using one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), graphics processing units (GPUs) or other.

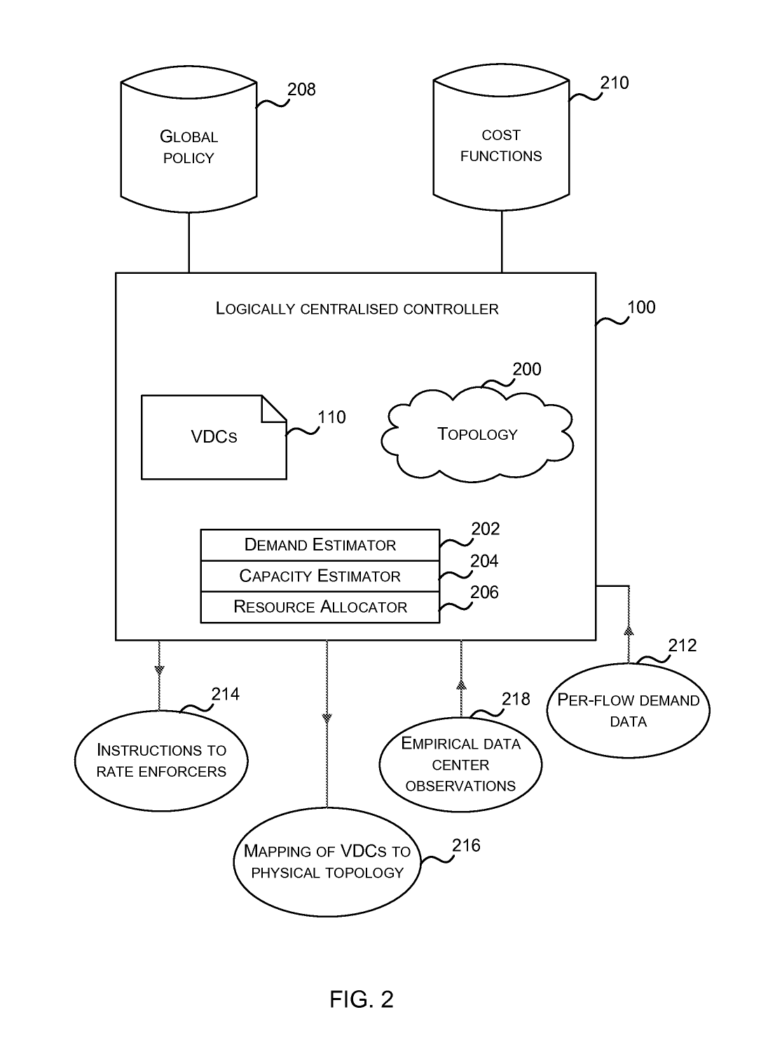

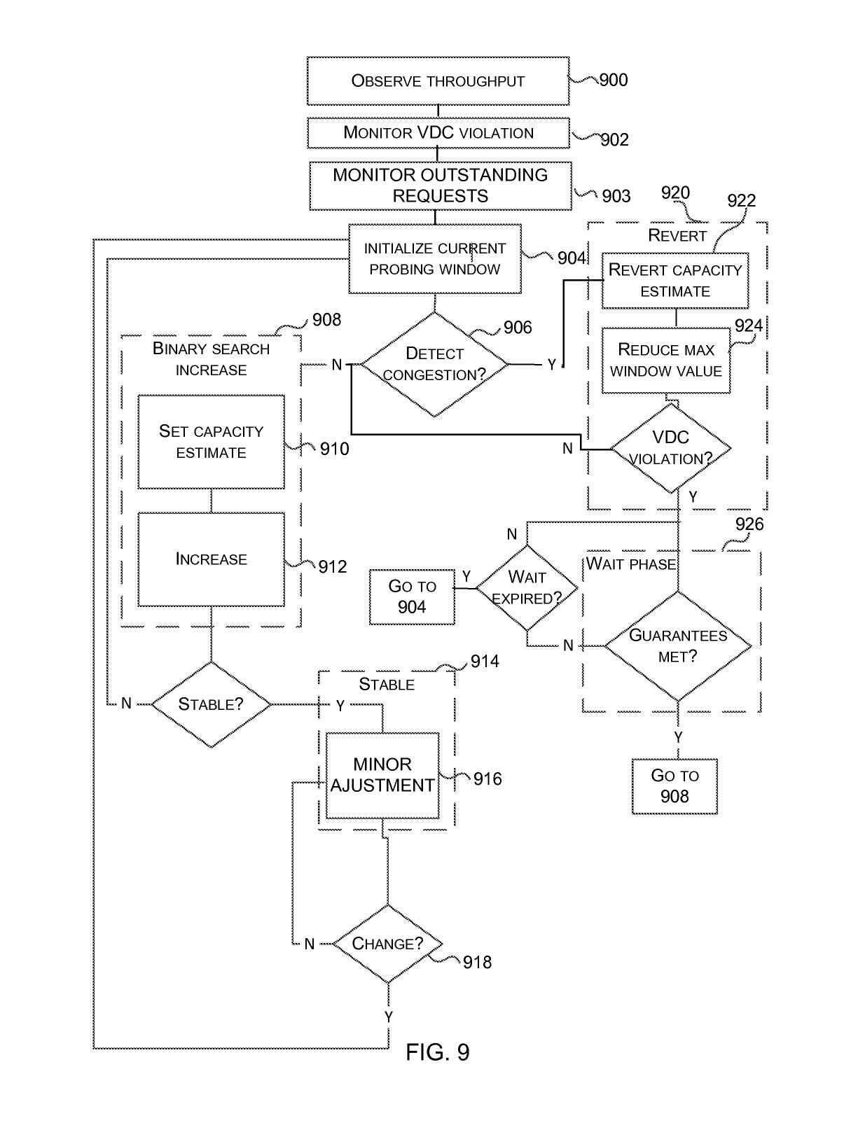

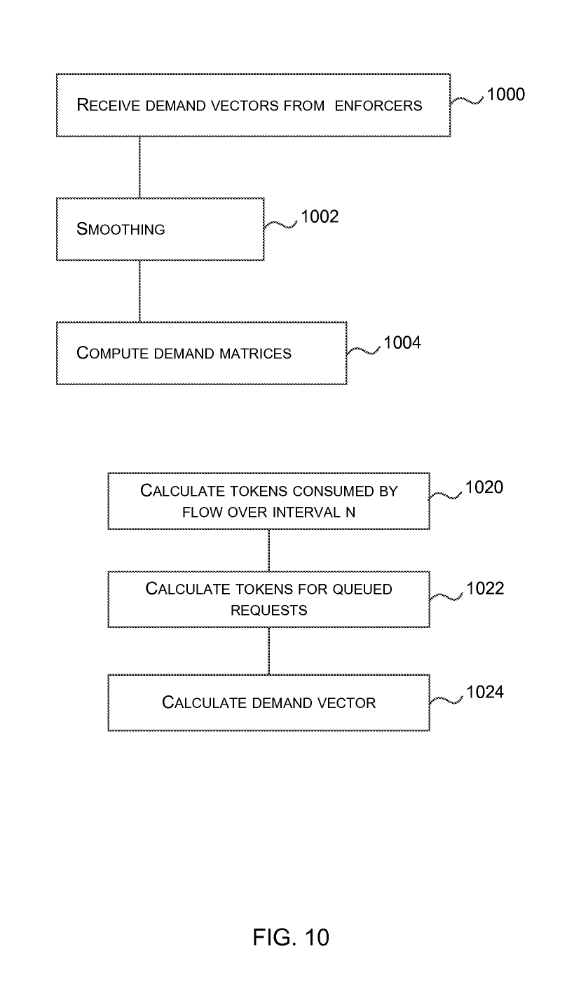

FIG. 2 is a schematic diagram of a logically centralized controller 100 of the datacenter of FIG. 1. It comprises a demand estimator 202, a capacity estimator 204 and a resource allocator 206, each of which are computer implemented using software and/or hardware. An example method implemented by the demand estimator 202 is described below with reference to FIG. 10. The demand estimator 202 is able to estimate current and future demands on different individual resources of the datacenter. An example method implemented by the capacity estimator is described below with reference to FIG. 9. The capacity estimator, in some examples, dynamically estimates available capacity of different individual resources of the datacenter. Available capacity varies over time because the amount of work in the datacenter varies over time and because resources may be shared. The resource allocator 206 computes, for different individual resources of the datacenter, an amount of the resource which may be used per unit time by a particular end-to-end flow of a particular virtual datacenter. The resource allocator may compute these amounts per unit time in a new metric, referred to herein as tokens per second, which takes into account a cost of serving a request to a particular resource.

The actual cost of serving a request at a resource of a datacenter can vary with request characteristics, concurrent workloads, or resource specifics. In some examples this is addressed by using a new metric. For example, each resource is assigned a pre-specified cost function that maps a request to its cost in tokens. Tenant guarantees across all resources and the network may be specified in tokens per second. The cost functions may be determined through benchmarking, from domain knowledge for specific resources, or from historical statistics.

In the examples described herein, various quantities may be measured in the new tokens per second metric. For example, demand, capacity, queue lengths, consumption of physical resources, consumption of virtual resources.

The controller 100 stores or has access to, data about the virtual datacenters 110 and data about the topology 200 of the physical datacenter. The data about the virtual datacenters is described with reference to FIG. 4 below. The topology 200 of the physical datacenter comprises details (such as maximum capacities, locations) of end points of the datacenter, any additional resources such as networked file stores, load balancers, middleboxes, and details about the interconnection.

As mentioned above, resources of the physical datacenter have associated cost functions. The controller 100 has access to or stores the cost functions 210. In some examples, the controller 100 has access to or stores a global policy 208 (also referred to as a global multi-resource allocation mechanism) which specifies how resources of the physical datacenter, which are left over, after implementation of the virtual datacenters, are to be allocated.

Inputs to the controller comprise at least empirical datacenter observations 218 such as traffic flow data, queue data, error reports and other empirical data. The controller 100 may also take as input per-flow demand data 212. For example, the per-flow demand data may be information about queues at enforcers which is sent to the controller 100 by the enforcers at the datacenter end points and/or directly from applications executing on the compute servers.

Outputs of the controller 100 comprise at least a mapping 216 of the virtual datacenters to the physical datacenter and instructions 214 to a plurality of enforcers in the physical datacenter. In an example, the instructions are vectors listing amounts per unit time of different resources of the physical datacenter which may be used by a particular flow. The amounts may be expressed using the new tokens per second metric mentioned above. However, it is not essential to use vectors. The instructions may be sent in any format.

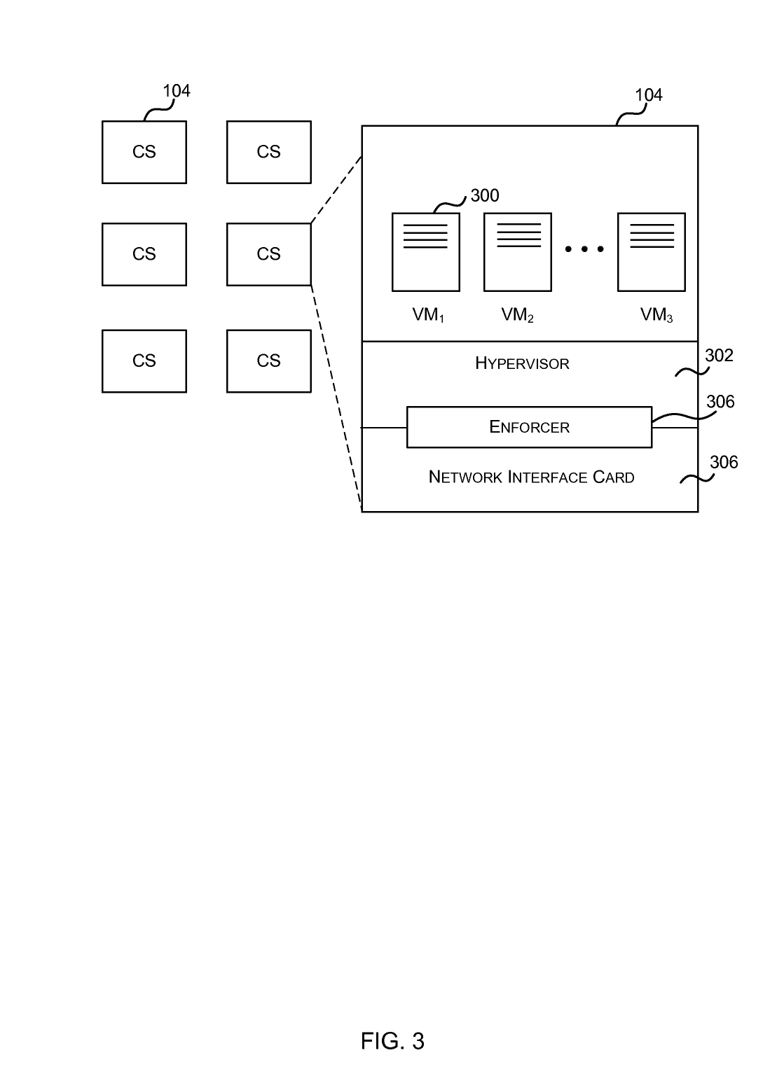

FIG. 3 is a schematic diagram of a plurality of physical compute servers 104 of a datacenter and with an exploded view of one of the compute servers. The exploded view of a compute server shows a plurality of virtual machines 300 executing at the compute server, a hypervisor 302 and a network interface card 306. Within the hypervisor 302 is an enforcer 304 which enforces rate allocations and collects local statistics.

FIG. 4 illustrates an example virtual datacenter 110 such as one of the virtual datacenters of FIG. 1. As mentioned above, a virtual datacenter is a specification of requirements. For example, the specification comprises a list of one or more datacenter endpoints (such as virtual machines at a compute server, or a compute server itself) to be interconnected by a network at the physical datacenter. The specification comprises a list of one or more additional resources which are not datacenter endpoints, such as load balancers, encryption devices, networked storage servers and others. The specification also comprises guarantees as explained above which may be throughput guarantees or non-throughput guarantees. For example, a minimum (or absolute) throughput guarantee for each link between an endpoint and the network, and for each specified additional resource. The minimum (or absolute) throughput guarantees may be specified in the new tokens per second metric. In the example of FIG. 4 the virtual datacenter specification comprises a plurality of virtual machines VM₁ to VM_{N} each connected to virtual network 400 by a link having an associated minimum throughput guarantee G₁ to G_{N}. The virtual datacenter also comprises a networked file store 402 with minimum throughput guarantee G_{S} and an encryption service 404 with minimum throughput guarantee G_{E}.

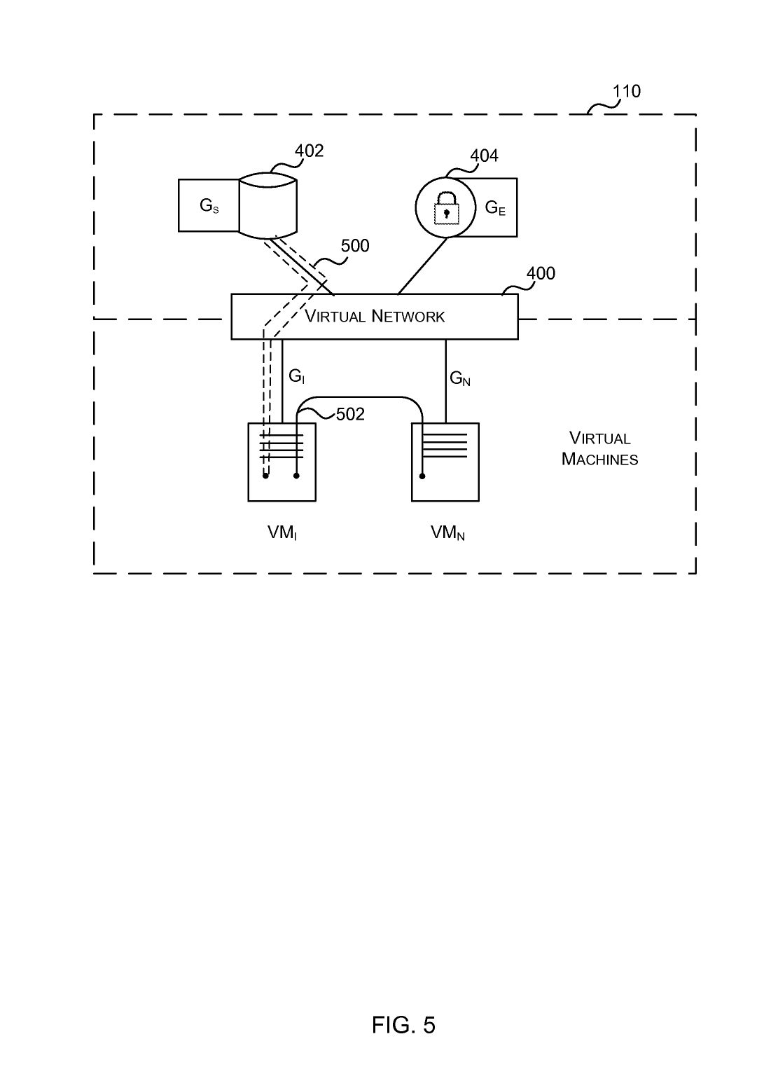

A virtual datacenter specification comprises one or more end-to-end flows. As mentioned above a flow is a path between two end points of a datacenter, along which traffic flows to implement a particular service. The flows may be detailed in the virtual datacenter specification or may be inferred. FIG. 5 is a copy of the virtual datacenter of FIG. 4 and with two flows 500, 502 indicated. Flow 500 goes from one virtual machine to file store 402 and then back to the same virtual machine. Flow 502 goes from one virtual machine to the other virtual machine.

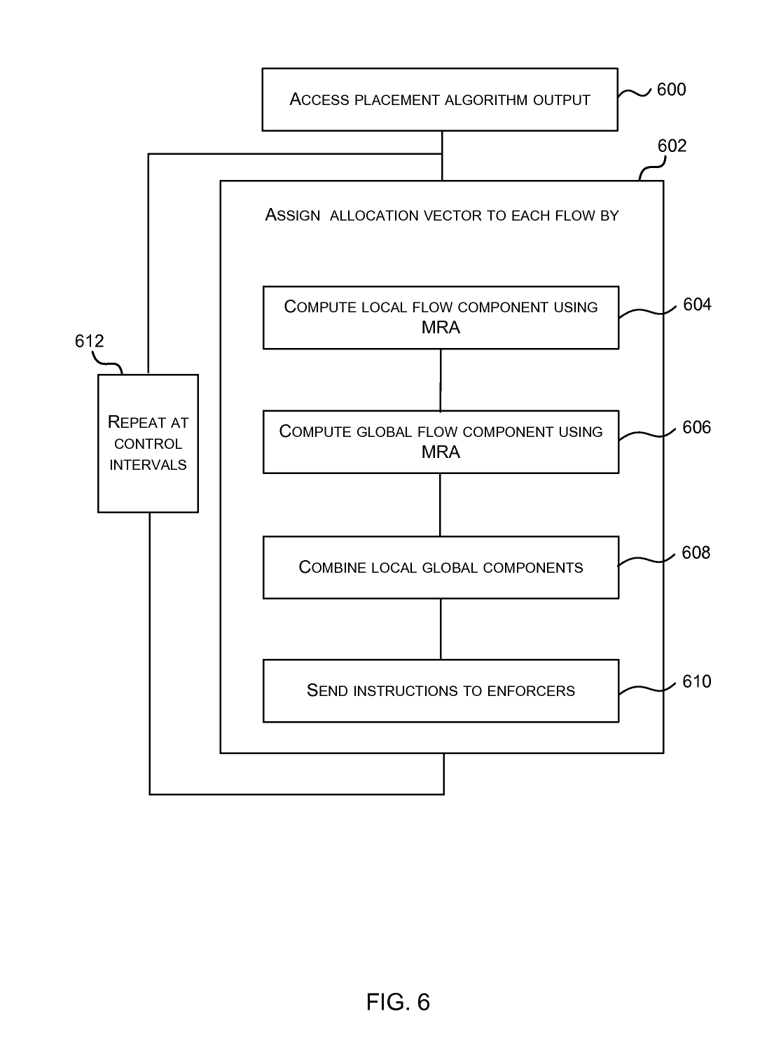

FIG. 6 is a flow diagram of a resource allocation process implemented by the controller 100 of FIG. 1 for example. The controller accesses 600 output of a placement algorithm. The placement algorithm takes the virtual datacenter specifications and the topology of the physical datacenter and computes a mapping or placement. The placement specifies which compute servers and which other resources of the physical datacenter are to be used by which virtual datacenters. As a result of this placement process the controller knows which physical resources exist on the paths of which flows of the individual virtual datacenters. Any suitable placement algorithm may be used. For example, Ballani et al. 2013, “Chatty tenants and the cloud network sharing problem” NSDI.

The resource allocator at the controller carries out a resource allocation process 602 which is repeated at control intervals 612 such as every second or other suitable time. The control interval 612 may be set by an operator according to the particular type of datacenter, the types of applications being executed at the datacenter, the numbers of compute servers and other factors.

In an example, the resource allocation process 602 comprises assigning a rate allocation vector to each flow of each virtual datacenter. A local flow component is computed 604 using multi-resource allocation and then a global flow component is computed 606 also using multi-resource allocation. The local and global flow components are combined 608 and the resulting allocation is sent 610 as instructions to the enforcers in the physical datacenter. By using a two stage approach improved efficiency of datacenter resource allocation is achieved. Previous approaches have not used this type of two-stage approach. However it is not essential to use a two stage process; it is also possible to use only the local flow allocation; or to combine the local and global allocation steps.

Any suitable multi resource allocation mechanism may be used which is able to distribute multiple types of resources among clients with heterogeneous demands. An example of a suitable multi-resource allocation mechanism is given in Bhattacharya, D et al. “Hierarchical scheduling for diverse datacenter workloads” in SOCC, Oct. 2013. For example, the multi-resource allocation mechanism for m flows and n resources provides the interface:

A←MRA(D, W, C)

Where A, D and W are m×n matrices, and C is an n-entry vector. D_{i, j} represents the demand of flow i for resource j, or how much of resource j flow i is capable of consuming in a control interval. Aᵢⱼ contains the resulting demand-aware allocation (i.e., A_{i, j}≦D_{i, j} for all i and j). W contains weight entries used to bias allocations to achieve a chosen objective (e.g., weighted fairness, or revenue maximization). C contains the capacity of each resource.

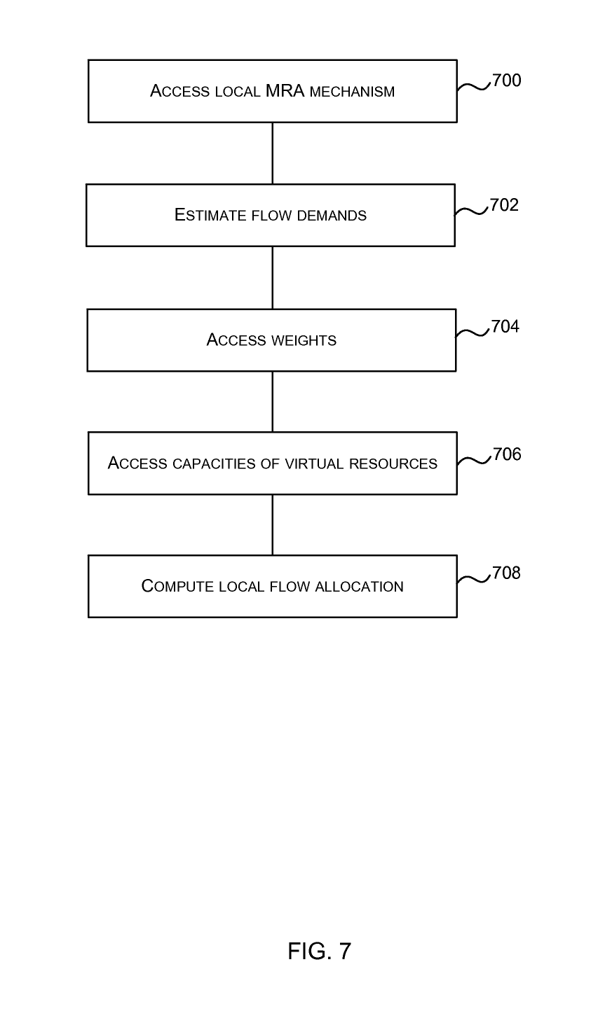

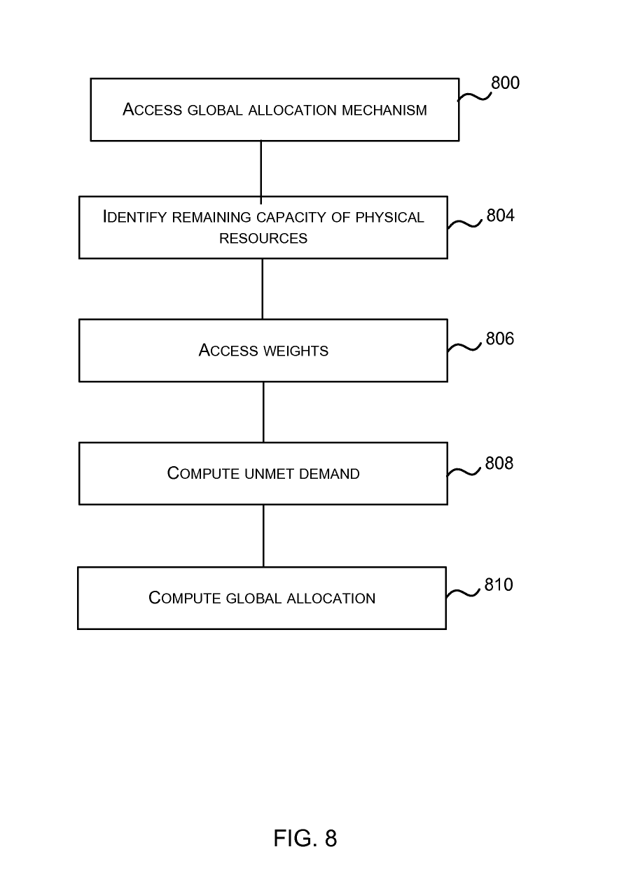

More detail about computing the local flow component is given with reference to FIG. 7 and more detail about the global flow component is given with reference to FIG. 8.

With reference to FIG. 7 the resource allocator of the controller accesses 700 a tenant's local multi-resource allocation mechanism. For example, a tenant may be able to choose a local multi-resource allocation mechanism, denoted by the symbol MRA_{L}, to give the tenant control over how its guaranteed resources are assigned to its flows. For example, tenants who want to divide their virtual datacenter resources fairly across their flows may choose a mechanism that achieves dominant-resource fairness or bottleneck-based fairness. Tenant t's local allocation matrix A^{t} is given by:

A^{t}←MRA_{L}(D^{t}, W^{t}, C^{t})

D^{t} and W^{t} are demand and weight matrices containing only t's flows, and C^{t} is the capacity vector containing the capacities of each virtual resource in t's virtual datacenter. These capacities correspond to the tenant's guarantees, which are static and known a priori (from the virtual datacenter specification). W^{t} may be set to a default (such as where all entries are 1) but can be overridden by the tenant.

The resource allocator of the controller estimates 702 the flow demands of D^{t}, for example, using the process of FIG. 9. The resource allocator also accesses 704 the weights to enter into the weight matrix W and accesses the capacities of the virtual resources in t's virtual datacenter from the virtual datacenter specification. This information is applied to the tenant's local multi-resource allocation mechanism to compute the local allocation matrix A^{t} 708.

To achieve virtual datacenter elasticity, the resource allocator at the controller assigns unused resources to flows with unmet demand based on a global policy of the datacenter comprising a global multi-resource allocation mechanism MRA_{G}. Using the global multi-resource allocation mechanism gives a global allocation which may be expressed as an m×n matrix A^{G}, where m is the total number of flows across all tenants, and n is the total number of resources in the datacenter. A^{G} is given by:

A^{G}←MRA_{G}(D^{G}, W^{G}, C^{G})

The rate controller accesses 800 the global allocation mechanism which may be pre-stored at the controller or accessed from a library of global allocation mechanisms. The rate controller obtains estimates of the remaining capacities 804 of individual physical resources in the datacenter and populates these values in matrix C^{G}. This is done using the capacity estimator which implements a process such as that described with reference to FIG. 9 below. The rate controller accesses 806 weights to go in matrix W^{G}. For example, the weights may be derived from the tenants' virtual datacenters to allow spare resources to be shared in proportion to up-front payment (a weighted fair allocation), or set to 1 to allow a fair (payment-agnostic) allocation. The rate controller computes unmet demand 808 for each flow, across each physical resource after running the local allocation step. Entries for resources that are not in a flow's path may be set to zero. Unmet demand may be computed using the demand estimator as described with reference to FIG. 10. The rate controller is then able to compute 810 the global allocation A^{G} by inputting the capacity, weights and demand values into the global multi-resource allocation mechanism.

More detail about how capacity is estimated is now given with reference to FIG. 9. The process of FIG. 9 is implemented by the capacity estimator of the controller. The process comprises observing 900 throughput of the resource. For example, this quantity is expressed in a metric that takes into account cost of serving requests at the resource (such as tokens per second as mentioned above). The controller uses the throughput data to monitor 902 for violation of any of the virtual datacenter specifications by the resource. In some examples, outstanding requests at the resource are monitored 903.

A current probing window is obtained 904 (where the process is already underway) or initialized (where the process begins). The probing window is a range of values in which the resource's actual capacity is expected to lie. The probing window is characterized by its extremes, minW and maxW, and is constantly refined in response to the presence or absence of congestion signals. The current capacity estimate C_{EST} is within the probing window and is used by the controller for rate allocation. The refinement of the probing window comprises four phases: a binary search increase phase 908, a revert phase 920, a wait phase 926 and a stable phase 914.

If congestion is not detected at decision point 906 the binary search increase phase 908 is entered. Detecting congestion comprises finding a virtual datacenter violation 902. In the binary search increase phase 908, the controller increases the capacity estimate, for example, by setting the capacity estimate 910 to a value within the probing window, such as the mid-point of the probing window or any other suitable value in the probing window. The controller also increases minW 912, for example, to the previous capacity estimate as a lack of congestion implies the resource is not overloaded and its actual capacity exceeds the previous estimate. This process repeats until stability is reached, or until congestion is detected.

When congestion is detected at decision point 906 the revert phase 920 is entered. The controller reverts 922 the capacity estimate, for example, to minW. This ensures that the resource is not overloaded for more than one control interval. Further maxW is reduced 924, for example, to the previous capacity estimate since the resource's actual capacity is less than this estimate. A check is then made for any VDC (virtual datacenter) violation. If no VDC violation is found the process goes to the binary search increase phase 908. If VDC violation is detected then the process moves to a wait phase 926.

Suppose the wait phase 926 is entered. The capacity estimate, set to minW in the revert phase, is not changed until the virtual datacenter guarantees are met again. This allows the resource, which had been overloaded earlier, to serve all outstanding requests. This is beneficial where the resource is unable to drop requests as is often the case with resources that are not network switches. When the guarantees are met the process moves to the binary search increase phase 908. When the guarantees are not met a check is made to see if a wait timer has expired. If not the wait phase is re-entered. If the wait timer has expired then the process goes to step 904.

After the binary search phase 908 a check is made to see whether the stable phase 914 is to be entered. The stable phase 914 is entered once the probing window size reaches a threshold such as 1% of the maximum capacity of the resource (or any other suitable threshold). During the stable phase the capacity estimate may be adjusted 916 in response to minor fluctuations in workload. In an example, the average number of outstanding requests (measured in tokens) at the resource during the control interval is tracked. This average is compared to the average number of outstanding requests O at the resource at the beginning of the stable phase. The difference between these observations, weighted by a sensitivity parameter, is subtracted from the current capacity estimate. O serves as a prediction of resource utilization when the resource is the bottleneck. When the current outstanding requests exceed this amount, the resource has to process more requests than it can handle in a single control interval and the estimate is reduced as a result. The opposite also applies.

If a change is detected 918 the estimation process restarts. For example, if a virtual datacenter violation is detected, or if significant changes in the demand reaching the resource from that of the beginning of the stable phase are detected. If a change is not detected at decision point 918 then the process moves back to the minor adjustment process of box 916.

In some examples the method of FIG. 9 is arranged to check for significant workload changes at the beginning of the process. In this way, irrespective of the state the estimation is in, such a workload change causes the process of FIG. 9 to restart.

More detail about how demand is estimated is now given with reference to FIG. 10. The process of FIG. 10 boxes 1000, 1002 and 1004 are implemented by the demand estimator of the controller for each individual resource that it is desired to estimate the demand of. The process of FIG. 10 boxes 1020, 1022 and 1024 is implemented at an enforcer at an end point of a flow in the physical datacenter. A row in the demand matrix D represents the demand vector for a flow, which in turn, contains the demand in tokens for each resource along the flow's path. The controller receives 1000 demand vectors from the enforcers. It smooths the estimates to avoid over-reacting to bursty workloads. For example, the smoothing uses an exponentially weighted moving average or any other smoothing process. The controller uses the smoothed demand vectors to compute demand matrices for each resource. At a high level, the enforcer at a flow's source uses requests processed during the current and previous control intervals as well as queuing information in order to estimate a flow's demand for the next interval. For example, an enforcer calculates 1020 the number of tokens consumed by its flow over the current and previous control intervals. The enforcer does this using the cost functions which it stores or has access to from a remote location. In an example, the enforcer assesses individual requests passing through it to calculate the cost in tokens for that specific request. This enables requests of different sizes to be taken into account for example. The enforcer also calculates the number of tokens 1022 of the currently queued requests of the flow. This information is then used to calculate the demand vector 1024.

In some examples the process at the enforcer for calculating the demand vector is arranged to take into account the situation where the flow may be a closed-loop flow (as opposed to an open-loop flow). An open-loop flow has no limit on the number of outstanding requests. A closed-loop flow maintains a fixed number of outstanding requests and a new request arrives when another completes. This is done by the enforcer monitoring the average number of requests in tokens (using the new metric) that are queued during a control interval and also monitoring the average number of requests in tokens that are outstanding during a control interval but which have been allowed past the enforcers. The demand vector for flow fat the next time interval is calculated as: the larger of the backlog vector of the flow for the previous time interval, and the utilization vector of the flow for the previous time interval plus the product of the average number of requests in tokens (using the new metric) that are queued during a control interval and the ratio of the utilization vector of the flow for the previous time interval and the average number of requests in tokens that are outstanding during a control interval. A backlog vector contains the tokens (in the new metric) needed for each resource of the flow in order to process all the requests that are still queued at the end of the interval. A utilization vector contains the total number of tokens (in the new metric) consumed for each resource by the flow's requests over the time interval. By taking into account that flows may be closed-loop in this way, the accuracy of the demand estimates are improved and so resource allocation in the datacenter is improved giving improved virtual datacenter performance.

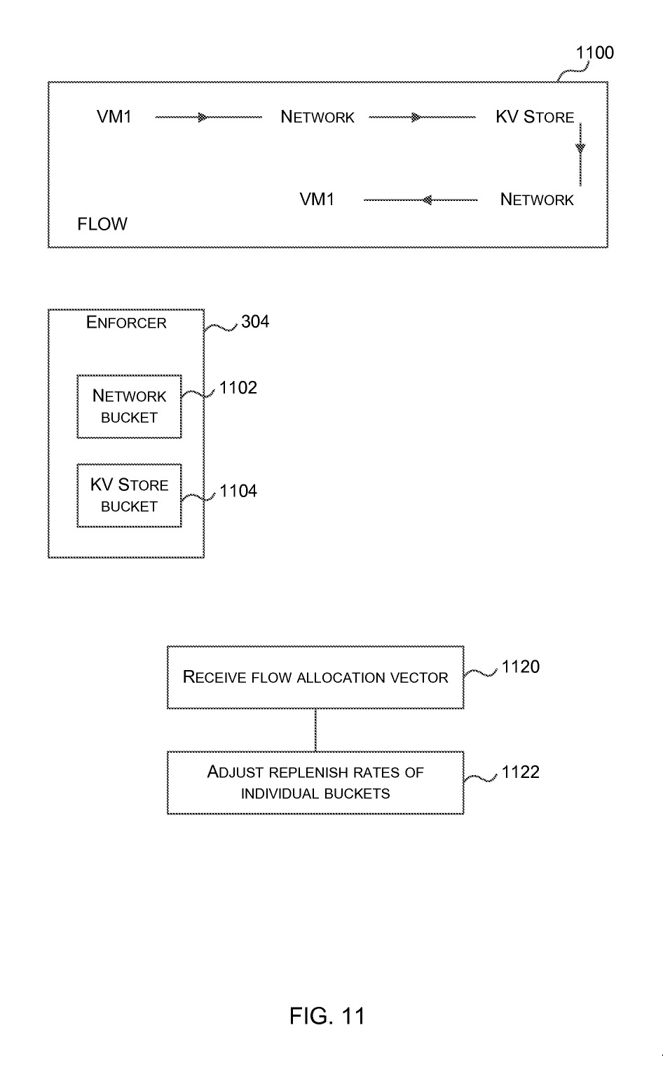

FIG. 11 is a schematic diagram of an end-to-end flow 1100 in a datacenter, an enforcer 304, and of a process 1120, 1122 at the rate enforcer. In this example the flow 1100 begins at virtual machine 1, travels through the network to a key value store, back to the network and to virtual machine 1. An enforcer 304 at virtual machine 1 has a network bucket 1102 and a key value store bucket 1104 in this example. Generally an enforcer has a bucket (also referred to as a queue) for each resource of a flow. The enforcer at virtual machine 1 receives a flow allocation vector 1120 from the controller. The rate allocation vector comprises a rate, in tokens per second, for each of the resources of the flow, which in this example are the network and the key value store. The rates have been calculated in a manner which takes into account virtual datacenters of the physical datacenter, local and global allocation policies, and demands and capacities of resources of the datacenter. The enforcer at virtual machine 1 adjusts replenish rates of the individual buckets of the flow on the basis of the rate allocation vector. In this way resources of the physical datacenter are allocated and controlled.

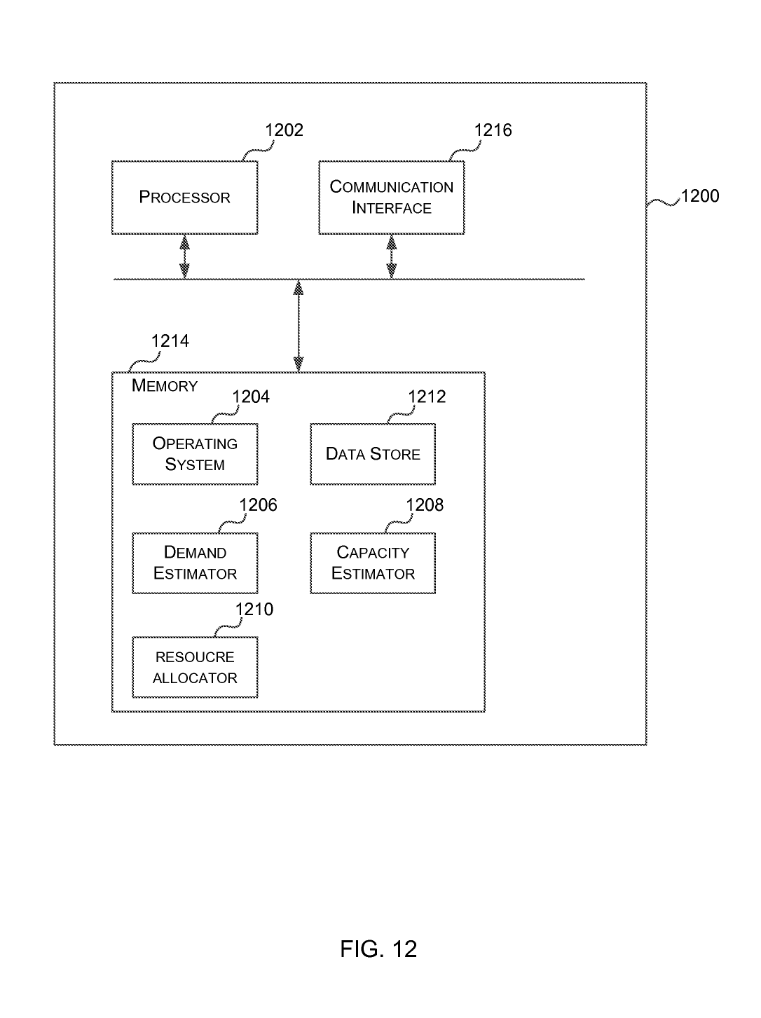

FIG. 12 illustrates various components of an exemplary computing-based device 1200 which may be implemented as any form of a computing and/or electronic device, and in which embodiments of any of the methods described herein may be implemented.

Computing-based device 1200 comprises one or more processors 1202 which may be microprocessors, controllers or any other suitable type of processors for processing computer executable instructions to control resources of a physical datacenter. In some examples, for example where a system on a chip architecture is used, the processors 702 may include one or more fixed function blocks (also referred to as accelerators) which implement a part of the methods described herein (rather than software or firmware). Platform software comprising an operating system 1204 or any other suitable platform software may be provided at the computing-based device to enable application software to be executed on the device. In an example computing-based device 1200 may further comprise a demand estimator 1206 to estimate demand of resources of the physical datacenter, a capacity estimator 1208 to estimate available capacity of resources of the physical datacenter, and a resource allocator 1210 to compute and send amounts of individual resources of different types which may be used. Data store 1212 may store global and local multi-resource allocation mechanisms, placement algorithms, parameter values, rate allocation vectors, demand vectors and other data.

The computer executable instructions may be provided using any computer-readable media that is accessible by computing based device 1200. Computer-readable media may include, for example, computer storage media such as memory 1214 and communications media. Computer storage media, such as memory 1214, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1214) is shown within the computing-based device 1200 it will be appreciated that the storage may be distributed or located remotely and accessed via a network or other communication link (e.g. using communication interface 1216).

In examples, a computer-implemented method of controlling a physical datacenter is described comprising:

accessing data about a plurality of virtual datacenters each virtual datacenter specifying a plurality of different types of resources having throughput guarantees;

implementing the virtual datacenters in the physical datacenter such that the throughput guarantees are met by;

computing, for individual flows of the virtual data centers implemented in the physical datacenter, a flow allocation comprising, for each of a plurality of different types of physical resources of the physical datacenter used by the flow, an amount of the physical resource that the flow can use; a flow being a path between endpoints of the physical datacenter along which messages are sent to implement a service; and

sending the flow allocations to enforcers in the physical datacenter, the enforcers arranged to use the flow allocations to control the rate of traffic in the flows such that, in use, performance influence between the virtual datacenters is reduced.

In this way a physical datacenter controller can implement virtual datacenters in an effective and efficient matter, without needing to change applications, guest operating systems or datacenter resources.

In examples, computing the flow allocations comprises computing, for each virtual datacenter, a local flow allocation taking into account a local policy associated with the virtual datacenter. This enables per-virtual data center criteria to be effectively taken into account.

In the above examples, computing the flow allocations may further comprise computing, a global flow allocation taking into account the local flow allocations and unused resources of the datacenter. This enables virtual datacenter elasticity to be provided.

For example, computing a local flow allocation comprises estimating a flow demand for individual flows, by at least observing consumption of traffic and queues of traffic associated with the individual flows in the physical datacenter. Using empirical data to estimate flow demand in real time gives accuracy and efficiency.

For example, computing a local flow allocation comprises estimating a flow demand for individual flows by taking into account that an individual flow can be a closed-loop flow. This improves accuracy even where it is not possible for the controller to tell whether a flow is open-loop or closed-loop.

In examples, dynamically estimating the capacity of at least some of the physical resources is achieved by observing traffic throughput of the at least some physical resources.

In examples, dynamically estimating the capacity further comprises monitoring violation of guarantees of the traffic throughput associated with the virtual datacenters, where the guarantees are aggregate guarantees aggregated over a set of flows passing through a resource of a virtual datacenter. By using violation of guarantees, the quality of the capacity estimates is improved and better suited for the resource allocation processes described herein. Even though resource throughput and virtual data center violation are implicit congestion signals, it is found that these signals are very effective for the capacity estimation process described herein.

Estimating capacity may comprise maintaining a probing window in which a capacity of a physical resource is expected to lie, the probing window being a range of capacity values, and repeatedly refining the size of the probing window on the basis of presence or absence of the violation of guarantees. By using a probing window refinement, a simple and effective way of computing the estimate is achieved which is readily implemented.

In examples where there is an absence of the violation of guarantees, the method may comprise setting an estimated capacity of the physical resource to a mid-point of the probing window and increasing a minimum value in the probing window.

In the presence of violation of guarantees, the method may comprise, reverting the estimated capacity to a previous value and reducing a maximum value of the probing window. This method may comprise waiting until guarantees associated with the virtual datacenters are met before proceeding with estimating the capacity of the physical resource.

In examples a stable phase is entered when the probing window reaches a threshold size, and the method comprises making adjustments to an estimated available capacity during the stable phase. By making adjustments in the stable phase significant improvement in quality of results is achieved.

In examples the amount of the physical resource that the flow can use is calculated in tokens per unit time, where a token is a unit which takes into account a cost of serving a request to the physical resource.

In examples at least some of the physical resources comprise resources selected from: networked storage servers, encryption devices, load balancers, key value stores.

In another example, there is described a method of dynamically estimating the available capacity of a physical resource of a datacenter comprising:

monitoring, at a processor, total throughput across the resource;

accessing guarantees specified in association with a plurality of virtual datacenters implemented in the datacenter using the resource;

detecting presence or absence of violation of at least one of the guarantees by the monitored throughput; and

updating an estimate of the available capacity on the basis of the presence or absence of the violation.

The above method may comprise maintaining a probing window in which a capacity of the physical resource is expected to lie, the probing window being a range of capacity values, and repeatedly refining the size of the probing window on the basis of presence or absence of violation of at least one of the guarantees.

The method of dynamically estimating specified above may comprise comprising monitoring outstanding requests at the resource and updating the estimate of the available capacity on the basis of the monitored outstanding requests when the probing window is below a threshold size. In the absence of violation of at least one of the guarantees, the method may comprise setting an estimated capacity of the physical resource to a mid-point of the probing window and increasing a minimum value in the probing window. In the presence of violation of at least one of the guarantees, the method may comprise reverting the estimated capacity to a previous value and reducing a maximum value of the probing window.

In examples a datacenter controller comprises:

a memory storing data about a plurality of virtual datacenters, each virtual datacenter specifying a plurality of different types of resources having throughput guarantees;

the memory holding instructions which when executed by a processor implement the virtual datacenters in the physical datacenter such that the throughput guarantees are met; and compute, for individual flows of the virtual datacenters implemented in the physical datacenter, a flow allocation comprising, for each of a plurality of different physical resources of the datacenter used by the flow, an amount of the physical resource that the flow can use; a flow being a path between endpoints of the datacenter along which messages are sent to implement a service; and

a communications interface arranged to send the flow allocations to enforcers in the datacenter, the enforcers arranged to use the flow allocations to control the rate of traffic in the flows such that, in use, performance influence between the virtual datacenters is reduced.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method of controlling a physical datacenter comprising:
accessing data about a plurality of virtual datacenters each virtual datacenter specifying a plurality of different types of resources having throughput guarantees;
implementing the virtual datacenters in the physical datacenter such that the throughput guarantees are met by;
computing, for individual flows of the virtual data centers implemented in the physical datacenter, a flow allocation comprising, for each of a plurality of different types of physical resources of the physical datacenter used by the flow, an amount of the physical resource that the flow can use; a flow being a path between endpoints of the physical datacenter along which messages are sent to implement a service; and
sending the flow allocations to enforcers in the physical datacenter, the enforcers arranged to use the flow allocations to control the rate of traffic in the flows such that, in use, performance influence between the virtual datacenters is reduced.

2. A method as claimed in claim 1 wherein computing the flow allocations comprises computing, for each virtual datacenter, a local flow allocation taking into account a local policy associated with the virtual datacenter.

3. A method as claimed in claim 2 wherein computing the flow allocations further comprises computing, a global flow allocation taking into account the local flow allocations and unused resources of the datacenter.

4. A method as claimed in claim 2 wherein computing a local flow allocation comprises estimating a flow demand for individual flows, by at least observing consumption of traffic and queues of traffic associated with the individual flows in the datacenter.

5. A method as claimed in claim 2 wherein computing a local flow allocation comprises estimating a flow demand for individual flows by taking into account that an individual flow can be a closed-loop flow.

6. A method as claimed in claim 1 comprising dynamically estimating the capacity of at least some of the physical resources by observing traffic throughput of the at least some physical resources.

7. A method as claimed in claim 6 wherein dynamically estimating the capacity further comprises monitoring violation of guarantees of the traffic throughput associated with the virtual datacenters, where the guarantees are aggregate guarantees aggregated over a set of flows passing through a resource of a virtual datacenter.

8. A method as claimed in claim 6 comprising maintaining a probing window in which a capacity of a physical resource is expected to lie, the probing window being a range of capacity values, and repeatedly refining the size of the probing window on the basis of presence or absence of the violation of guarantees.

9. A method as claimed in claim 8 comprising, in the absence of the violation of guarantees, setting an estimated capacity of the physical resource to a value within the probing window and increasing a minimum value of the probing window.

10. A method as claimed in claim 9 comprising, in the presence of violation of guarantees, reverting the estimated capacity to a previous value and reducing a maximum value of the probing window.

11. A method as claimed in claim 10 comprising waiting until guarantees associated with the virtual datacenters are met before proceeding with estimating the capacity of the physical resource.

12. A method as claimed in claim 8 comprising entering a stable phase when the probing window reaches a threshold size, and making adjustments to an estimated available capacity during the stable phase.

13. A method as claimed in claim 1 wherein the amount of the physical resource that the flow can use is calculated in tokens per unit time, where a token is a unit which takes into account a cost of serving a request to the physical resource.

14. A method as claimed in claim 1 wherein at least some of the physical resources comprise resources selected from: networked storage servers, encryption devices, load balancers, key value stores.

15. A method of dynamically estimating the available capacity of a physical resource of a datacenter comprising:
monitoring, at a processor, total throughput across the resource;
accessing guarantees specified in association with a plurality of virtual datacenters implemented in the datacenter using the resource;
detecting presence or absence of violation of at least one of the guarantees by the monitored throughput; and
updating an estimate of the available capacity on the basis of the presence or absence of the violation.

16. A method as claimed in claim 15 comprising maintaining a probing window in which a capacity of the physical resource is expected to lie, the probing window being a range of capacity values, and repeatedly refining the size of the probing window on the basis of presence or absence of violation of at least one of the guarantees.

17. A method as claimed in claim 15 comprising monitoring outstanding requests at the resource and updating the estimate of the available capacity on the basis of the monitored outstanding requests when the probing window is below a threshold size.

18. A method as claimed in claim 17 comprising, in the absence of violation of at least one of the guarantees, setting an estimated capacity of the physical resource to a value within the probing window and increasing a minimum value of the probing window.

19. A method as claimed in claim 18 comprising in the presence of violation of at least one of the guarantees, reverting the estimated capacity to a previous value and reducing a maximum value of the probing window.

20. A datacenter controller comprising:
a memory storing data about a plurality of virtual datacenters, each virtual datacenter specifying a plurality of different types of resources having throughput guarantees;
the memory holding instructions which when executed by a processor implement the virtual datacenters in the physical datacenter such that the throughput guarantees are met; and compute, for individual flows of the virtual datacenters implemented in the physical datacenter, a flow allocation comprising, for each of a plurality of different physical resources of the datacenter used by the flow, an amount of the physical resource that the flow can use; a flow being a path between endpoints of the physical datacenter along which messages are sent to implement a service; and
a communications interface arranged to send the flow allocations to enforcers in the physical datacenter, the enforcers arranged to use the flow allocations to control the rate of traffic in the flows such that, in use, performance influence between the virtual datacenters is reduced.
